(19) United States
(12) Patent Application Publication
(10) Pub. No.: US 2002/0096023 A1
(43) Pub. Date: Jul. 25, 2002

(54) Adapter used in conjunction with a hand drill for installing insert fittings of a sprinkler or irrigation system

(76) Inventor: William R. Sanford, Riverside, CA (US)

Correspondence Address: ROZSA & CHEN LLP, Suite 1601, 15910 Ventura Boulevard, Encino, CA, 91436-2815, US

(21) Appl. No.: 09/770,022

(22) Filed: Jan. 25, 2001

(51) Int. Cl. B25B 13/00

(52) U.S. Cl. 81/124.2

(57) ABSTRACT

An adapter for a portable hand drill which facilitates the quick and easy installation of elbow insert fittings into flexible hoses of a sprinkler or irrigation system. The adapter can be easily inserted and locked into the portable hand drill, and then the head section of the adapter is formed with the shape of an elbow insert fitting, where the trigger mechanism of the hand drill is depressed and the torque power of the hand drill rotates the head section of the adapter which in turn causes the elbow insert fitting to rotate about its turning axis to thereby insert into the flexible hose. The adapter can be used with an extension for facilitating and speeding up the installation of straight insert fittings and T-shaped insert fittings. The extension has a hexagonal shaped shaft section and a retaining section. The retaining section is installed within the adapter while the hexagonal shaped shaft section extends outwardly from the adapter.

### BACKGROUND OF THE INVENTION

1. Field of the Invention

The present invention relates generally to the field of adapters for use with a hand drill. More particularly, the present invention relates to the field of adapters which can be used with a cordless hand drill for facilitating the installation of insert fittings of a sprinkler or irrigation system.

2. Description of the Prior Art

Specifically, insert fittings for a sprinkler or irrigation system are well known in the art. To install insert fittings into flexible hoses according to conventional practice, the installer manually forces the insert fitting into the flexible hose. Therefore, this manual process of installing the insert fittings into flexible hoses is slow and a considerable amount of time is consumed in the process.

The following eleven (11) prior art patents are found to be pertinent to the field of the present invention:

1. U.S. Pat. No. 798,325 issued to Daddysman, Jr. on Aug. 29, 1905 for “Wrench” (hereafter the “Daddysman Patent”);

2. U.S. Pat. No. 949,711 issued to McLane on Feb. 15, 1910 for “Wrench For Screwing Flanges Or Sockets On Pipes” (hereafter the “McLane Patent”);

3. U.S. Pat. No. 1,181,565 issued to Block on May 2, 1916 for “Rod Clamp” (hereafter the “Block Patent”);

4. U.S. Pat. No. 1,867,372 issued to McGuckin on Jul. 12, 1932 for “Grease Fitting Tool” (hereafter the “McGuckin Patent”);

5. U.S. Pat. No. 2,691,912 issued to Jones on Oct. 19, 1954 for “Anvil Type Wrench” (hereafter the “Jones Patent”);

6. U.S. Pat. No. 4,275,621 issued to Mallott, Sr. on Jun. 30, 1981 for “Implement For Attaching Hangers” (hereafter the “Mallott Patent”);

7. U.S. Pat. No. 4,724,731 issued to Onofrio on Feb. 16, 1988 for “Lag Driver” (hereafter the “Onofrio Patent”);

8. U.S. Pat. No. 4,984,489 issued to Krauthamer on Jan. 15, 1991 for “Window Handle Turning Accessory” (hereafter the “Krauthamer Patent”);

9. U.S. Pat. No. 5,048,378 issued to Nikolas on Sep. 17, 1991 for “Tool And Method For Faucet Nut Installation” (hereafter the “Nikolas Patent”);

10. U.S. Pat. No. 5,199,333 issued to Snyder, Jr. on Apr. 6, 1993 for “Wedge-Gripping Tie Rod End Socket Wrench” (hereafter the “Snyder Patent”);

11. U.S. Pat. No. 5,425,290 issued to Fought et al. on Jun. 20, 1995 for “Doorstop Installation Wrench” (hereafter the “Fought Patent”);

12. U.S. Pat. No. 5,615,587 issued to Foerster, Jr. on Apr. 1, 1997 for “Deep-Socket Driver Apparatus” (hereafter the “Foerster Patent”);

13. U.S. Pat. No. 5,943,922 issued to Rolfe on Aug. 31, 1999 for “Chuck For Threaded Fasteners” (hereafter the “Rolfe Patent”);

14. U.S. Pat. No. 6,010,154 issued to Payne et al. on Jan. 4, 2000 for “Trailer Landing Gear Device” (hereafter the “Payne Patent”);

15. U.S. Pat. No. 6,044,732 issued to Astle on Apr. 4, 2000 for “Plumbing Tool” (hereafter the “Astle Patent”); and

16. U.S. Pat. No. 6,062,110 issued to Julio et al. on May 16, 2000 for “Wrench Adapted For Pressurized Gas Tank Valves” (hereafter the “Julio Patent”).

The Daddysman discloses a wrench. The handle of the wrench comprises two tubular telescoping parts, one fitting into the other.

The McLane Patent discloses a wrench for screwing flanges or sockets on pipes.

The Block Patent discloses a rod clamp. The clamp includes a housing with two spaced apart parallel sidewalls for receiving a cross arm of a valve between the sidewalls.

The McGuckin Patent discloses a grease fitting tool which is a socket wrench with a slotted side. The slot is comparatively narrow and the wrench may be used on a Zerk fitting in which the grease nipple is inserted at practically any radical angle. The wrench will also operate with an Alemite fitting which consists essentially of a straight sided tubular element with two opposed projecting pins.

The Jones Patent discloses an anvil type wrench.

The Mallott Patent discloses an implement for attaching hangers. The hanger is secured by a pivoted cover which releases the hanger from the body upon a contact activator positioned on the implement contacting the ceiling or wall. Upon such contact the cover is opened and the continued rotation of the implement immediately frees the hanger from the implement without further action by the operator.

The Onofrio Patent discloses a lag driver for threaded fasteners. It includes a body member an outer sleeve member. The body member has a hex shaped shaft which includes an intermediate portion, a body portion, a tapered portion, a pair of arm members, and a pair of semicircular troughs. The outer sleeve member has a tube fitted to a portion of the body member.

The Krauthamer Patent discloses a window handle turning accessory. The accessory is adapted for a hand drill which cooperates with the crank handle of the opening mechanism of a casement window. The accessory includes a shaft which is gripped by the chuck of the drill. A forwardly projecting crank handle-contacting head is adapted to slide over the crank handle. The head has a side opening with a pair of edges which push against one side of the crank handle in order to rotate.

The Nikolas Patent discloses a tool and method for faucet nut installation. The tool is adapted for attachment to an electric drill. The tool has a socket and a drive shaft coupled to the socket. The shaft fits into the jaws of the drill chuck. The socket fits over and encompasses the nipple of the faucet assembly.

The Snyder Patent discloses a wedge-gripping tie rod end socket wrench. The wrench is adapted to engage a tie rod end of an automobile steering system for rotating the tie rod for either loosening or tightening.

The Fought Patent discloses a doorstop installation wrench. It includes a handle which is coaxially aligned with an inner sleeve but can rotate and slide with respect thereto. When the inner sleeve is attached to a rotary power tool, the operator's hand can hold the handle to guide the placement and angle of the doorstep. The handle is spring biased away from the mandrel end of the inner sleeve, but can be slid toward the mandrel to allow the doorstop to ingress/egress the chamber of the inner sleeve.

The Foerster Patent discloses a deep-socket driver apparatus for rotating nuts onto bolts.

The Rolfe Patent discloses a chuck for threaded fasteners. It includes a retainer sleeve formed with a slotted base plate and an adjacent cut-out area having opposed recesses. The eye formation of a threaded fastener is inserted into the sleeve cut-out with opposite portions of the eye nested within the two sleeve notches and the fastener shank disposed within the slot in the base plate.

The Payne Patent discloses a trailer landing gear device. It comprises a rigid cylindrical body having a closed end portion which is coupleable to a rotatable drive shaft of a drive means, and an open end portion which is adapted to releaseably grip the end of a crank shaft of a mechanical landing gear drive mechanism.

The Astle Patent discloses a plumbing tool for tightening the drain assembly of a shower. The tool comprises a shaft with opposite proximal and distal ends, and a tubular first bell reducer with open proximal and distal ends. The distal end of the shaft is inserted into the proximal end of the first bell reducer. A tubular second bell reducer has open proximal and distal ends. The distal end of the first bell reducer is inserted into the proximal end of the second bell reducer. The distal end of the second bell reducer has a plurality of notches to define a plurality of teeth around the distal end of the second bell reducer.

The Julio Patent discloses a wrench adapted for pressurized gas tank valves. The wrench is specially adapted to fit on the valves on liquid propane gas (LPG) tanks.

It is desirable to provide an adapter used in conjunction with a portable hand drill for facilitating and speeding up the installation of elbow insert fittings into flexible hoses of a sprinkler or irrigation system in a much more efficient way. It is also desirable to provide an extension mounted to an adapter which is used in conjunction with a portable hand drill for facilitating and speeding up the installation of straight-shaped insert fittings and T-shaped insert fittings into flexible hoses of a sprinkler or irrigation system.

### SUMMARY OF THE INVENTION

The present invention is a unique adapter for a portable hand drill or driving means which facilitates the quick and easy installation of elbow insert fittings into flexible hoses of a sprinkler or irrigation system. The adapter can be easily inserted and locked into the portable hand drill, and then the head section of the adapter is formed with the shape of an elbow insert fitting, where the trigger or other actuator of the hand drill is depressed and the torque power of the hand drill rotates the head section of the adapter which in turn causes the elbow insert fitting to rotate about its turning axis to thereby be inserted into the flexible hose.

It is an object of the present invention to provide an adapter for a portable hand drill or battery operated driving means which facilitates the quick and relatively effortless installation of elbow insert fittings into flexible hoses of a sprinkler or irrigation system.

It is a further object of the present invention to provide an apparatus which includes an adapter for a portable hand drill or battery operated driving means and an extension which can be used with the adapter, so that the extension facilitates the quick and relatively effortless installation of straight insert fittings and T-shaped insert fittings into flexible hoses of a sprinkler or irrigation system.

In the preferred embodiment of the present invention, the adapter is used with a driving means for facilitating and speeding up the installation of elbow insert fittings into flexible hoses of a sprinkler or irrigation system. The adapter includes a driving connection section and a head section, where the driving connection section is held in the jaws of the driving means. The driving means rotates the jaws which in turn rotates the driving connection section. The torque power of the driving means is transferred to the adapter and is sufficient to rotate the adapter and in turn when the adapter holds the elbow insert fitting thereto, the elbow insert fitting rotates which in turn causes an engagement portion to engage the flexible hose so that the elbow insert fitting is installed to the flexible hose.

In an alternative embodiment of the present invention, the apparatus includes an adapter and an extension, where the adapter is used in conjunction with a driving means for facilitating and speeding up the installation of straight insert fittings and T-shaped insert fittings into flexible hoses of a sprinkler or irrigation system. The adapter includes a driving connection section and a head section, where the driving connection section is held in the jaws of the driving means. The extension has a hexagonal shaped shaft section and a retaining section. The retaining section is installed within the adapter while the hexagonal shaped shaft section extends outwardly from the adapter. The driving means rotates the jaws which in turn rotates the driving connection section, which in turn rotates the extension. The torque power of the driving means is transferred to the adapter which in turn is transferred to the extension and is sufficient to rotate the extension and in turn when the extension is inserted within the insert fitting thereto, the insert fitting rotates which in turn causes an engagement portion to engage the flexible hose so that the insert fitting is installed to the flexible hose.

Further novel features and other objects of the present invention will become apparent from the following detailed description, discussion and the appended claims, taken in conjunction with the drawings.

### BRIEF DESCRIPTION OF THE DRAWINGS

Referring particularly to the drawings for the purpose of illustration only and not limitation, there is illustrated:

FIG. 1 is a perspective view of the present invention adapter used in conjunction with a portable hand drill for holding and installing an elbow insert fitting into a flexible hose of a sprinkler or irrigation system;

FIG. 2 is a perspective view of the present invention adapter;

FIG. 3 is a top plan view of the present invention adapter;

FIG. 4 is a cross-sectional view of the present invention adapter attached to a hand drill, partially shown, with the head section of the adapter holding the elbow insert fitting and threaded into a flexible tube of a sprinkler or irrigation system;

FIG. 5 is a perspective view of an alternative embodiment of the present invention apparatus used in conjunction with a portable hand drill for installing a straight insert fitting into a flexible hose of a sprinkler or irrigation system;

FIG. 6 is a perspective view of an extension in accordance with the present invention;

FIG. 7 is a front plan view of the extension shown in FIG. 6;

FIG. 8 is a cross-sectional view of the present invention apparatus attached to a hand drill, partially shown, with the adapter holding the extension and the extension inserted into the straight insert fitting and threaded into a flexible tube of a sprinkler or irrigation system; and

FIG. 9 is an illustrative view of the alternative embodiment of the present invention apparatus used in conjunction with a portable hand drill for installing an T-shaped insert fitting into a flexible hose of a sprinkler or irrigation system.

### DETAILED DESCRIPTION OF THE PREFERRED EMBODIMENTS

Although specific embodiments of the present invention will now be described with reference to the drawings, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention as further defined in the appended claims.

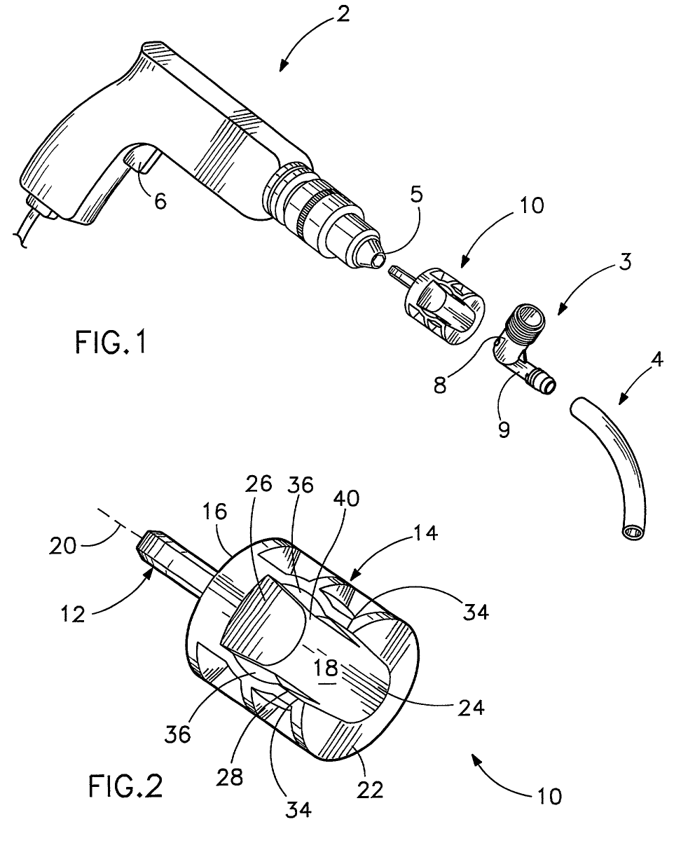

Referring to FIGS. 1, 2, 3 and 4, there is shown at 10 an adapter used in conjunction with a portable hand drill 2 (electric or a battery-operated) or other suitable driving means for facilitating and speeding up the installation of a right-angle elbow insert fitting 3 into a flexible hose or tube 4 of a sprinkler or irrigation system (not shown). The adapter 10 comprises a hexagonal shaped shaft section 12 or connection means and a head section 14. The shaft section is adapted to be selectively received and held in the chuck mechanism or jaws 5 of the portable hand drill 2. As best shown in FIG. 1, the portable hand drill 2 can be gripped by the user and a trigger or switch mechanism 6 can be selectively depressed to rotate the chuck mechanism 5 which in turn serves to rotate the shaft section 12 of the adapter 10. The torque power of the hand drill 2 is transferred to the adapter 10 and is generally sufficient to rotate the adapter 10 and in turn when the adapter 10 holds the elbow insert fitting 3 thereto, the elbow insert fitting rotates which in turn causes the engagement portion 9 to engage the flexible hose 4 so that the elbow insert fitting is installed to the flexible hose 4.

The head section 14 extends forwardly from the shaft section 12 and is generally of a cylindrical or conical configuration. Preferably, the head section 14 is made a hard plastic material and has a generally flat rear end 16. The shaft section 12 can be either integrally formed with the head section 14 or the shaft section can be inserted into an opening and then glued to the head section 14.

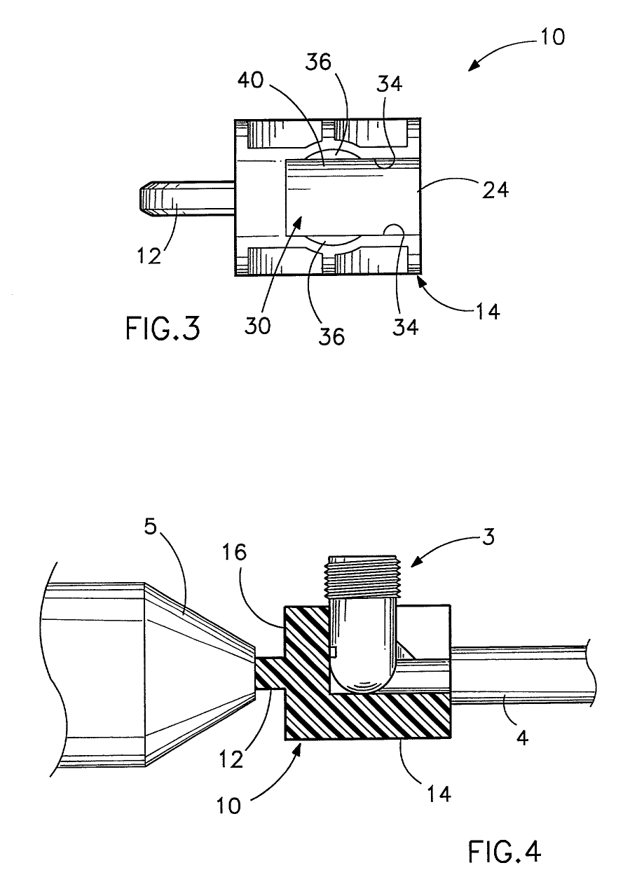

Referring to FIGS. 2 and 3, there is provided a generally cylindrical shaped center opening 18 which is molded or machined into the head section 14. The longitudinal axis of the center opening 18 is aligned with the rotative axis 20 of the adapter 10 as defined by the shaft section 12. The center opening 18 has a front end 22. The center opening 18 consists of a partial hollow horizontal cylinder channel 24 and a vertical interior wall section 26 which intersects the cylinder channel 24 and forms a surface corresponding to the shape of the engagement portion 9 of the elbow insert fitting 3. The diameter of the horizontal cylinder channel 24 of the head section 14 is sufficient so that it can easily receive the engagement portion 9 of the elbow insert fitting 3.

A side opening 30 is formed at the outside surface of the head section 14 to allow the elbow insert fitting 3 to be laterally placed within the center opening and removed from the adapter 10 after the elbow insert fitting is installed. Each side edge 34 (see FIG. 2) of the side opening 30 has a curved section 36 which extends downward and intersects with the horizontal cylinder channel 24. The curved section 36 forms a vertical cylinder channel 40 which corresponds to the shape of the connection portion 8 of the elbow insert fitting 3. The diameter of the vertical cylinder channel 40 is sufficient so that it can be easily received by the connection portion 8 of the elbow insert fitting 3. The diameter of the vertical cylinder channel 40 is slightly smaller than the diameter of the connection portion 8 so that the elbow insert fitting 3 is tightly secured thereto when the adapter 10 is turning to prevent the elbow insert fitting from flying out of the adapter.

Referring to FIGS. 1, 2, 3 and 4, in operation, the adapter 10 is located and locked into the chuck mechanism 5 of the portable hand drill 2. This is performed, as mentioned, by having the shaft section 12 of the adapter 10 secured within the chuck mechanism or movable jaws 5, in a well known and conventional manner. The elbow insert fitting 3 is laterally positioned within the head section 14 of the adapter 10 so that the engagement portion 9 is located within the horizontal cylinder section 24 and the connection portion 8 is located within the vertical cylinder section 40. Thus, the elbow insert fitting 3 passes through the side opening of the head section 14 and the interior vertical wall 26 is against the connection portion 8 of the elbow insert fitting 3. Then, the operator can depress the trigger mechanism 6 of the hand drill 2 and, in this manner, rotation of the shaft section 12 of the adapter 10 causes the head section 14 to correspondingly rotate. This, in turn, causes one of the side edges 34 (depending upon the direction of rotation of the shaft section and the head section) to contact one of the sides of the connection portion 8 of the elbow insert fitting 3 and, in this manner, the power or torque transmitted by the hand drill 2 is transferred through the head section 14 and this causes the elbow insert fitting 3 to rotate about its rotation axis. This in turn, causes the engagement portion 9 to be threaded into the flexible hose 4.

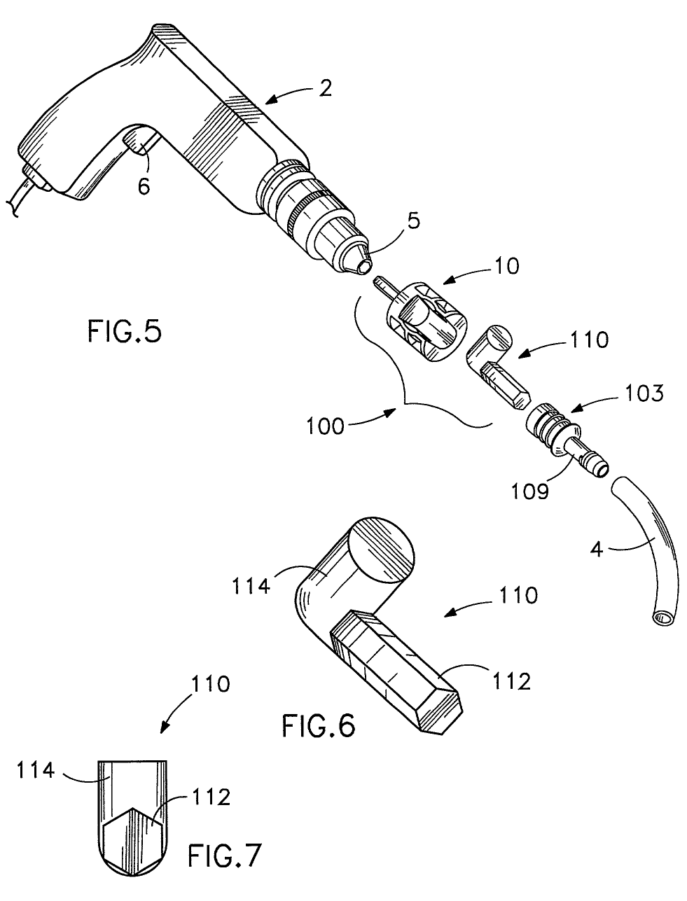

Referring to FIGS. 5, 6, 7, 8 and 9, there is shown at 100 an alterative embodiment of the present invention apparatus which includes the adapter 10 shown in FIGS. 1-4 and an extension 110. The parts of the adapter 10 have been numbered the same in the preceding embodiment, and the description thereof will not be repeated.

The adapter 10 is used in conjunction with a portable hand drill 2 (electric or a battery-operated) or other suitable driving means for facilitating and speeding up the installation of straight insert fittings 103 (see FIG. 5) and T-shaped insert fittings 104 (see FIG. 9) into a flexible hose or tube 4 of a sprinkler or irrigation system (not shown). As best shown in FIGS. 5 and 9, the portable hand drill 2 can be gripped by the user and a trigger or switch mechanism 6 can be selectively depressed to rotate the chuck mechanism 5 which in turn serves to rotate the shaft section 12 of the adapter 10. The torque power of the hand drill 2 is transferred to the adapter 10 which in turn is transferred to the extension and is generally sufficient to rotate the extension 110 and in turn when the extension 110 is inserted into the insert fitting 103 or 104, the insert fitting rotates which in turn causes the engagement portion 109 to engage the flexible hose 4 so that the insert fitting is installed to the flexible hose 4.

Referring to FIGS. 6 and 7, there is shown the extension 110 which includes a hexagonal shaped shaft section 112 and a retaining section 114 integrally connected or attached by suitable means to the shaft section 112. The retaining section 114 is shaped similar to the connection portion 8 of the elbow insert fitting 3 shown in FIGS. 1 and 4, except that the threaded end is removed from the retaining section 114.

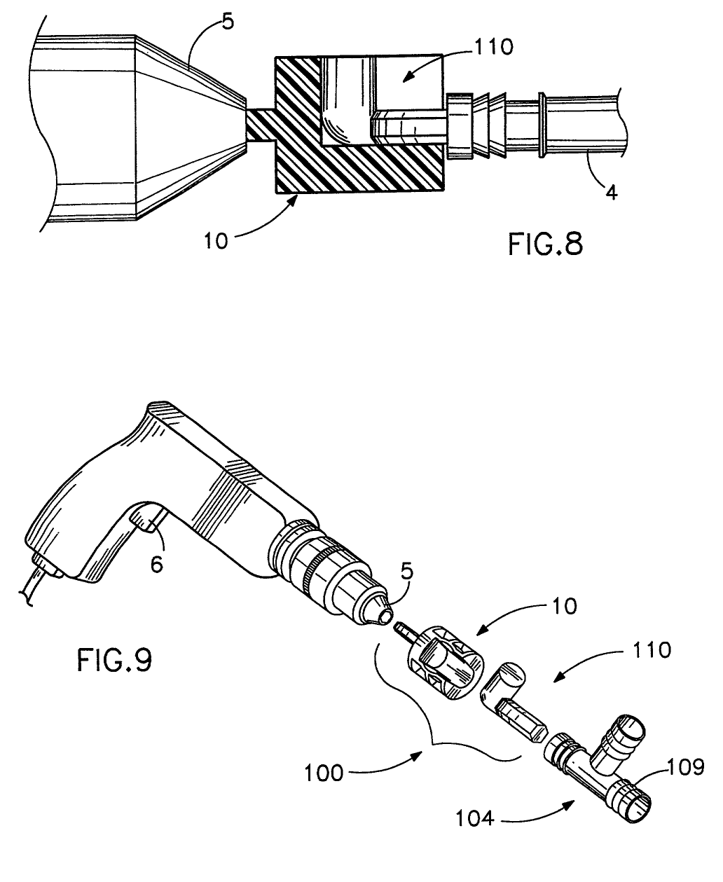

The retaining section 114 is installed within the adapter 10 while the hexagonal shaped shaft section 112 extends outwardly from the adapter 10 to be inserted into the straight insert fitting 103 as shown in FIG. 8. The hand drill 2 rotates the jaws 5 which in turn rotates the shaft section 12 of the adapter 10, which in turn rotates the extension 110. The torque power of the drill 2 is transferred to the adapter 10 which in turn is transferred to the extension 110 and is sufficient to rotate the extension 110 and in turn when the extension 110 is inserted within either one of the insert fittings 103 and 104, the insert fitting rotates which in turn causes the engagement portion 109 to engage the flexible hose 4 so that the insert fitting is installed to the flexible hose 4.

Referring to FIGS. 5 through 9, in operation, the adapter 10 is located and locked into the chuck mechanism 5 of the portable hand drill 2. This is performed, as mentioned, by having the shaft section 12 of the adapter 10 secured within the chuck mechanism or movable jaws 5, in a well known and conventional manner. The extension 110 is laterally positioned within the head section 14 of the adapter 10 so that the hexagonal shaped shaft section 112 is located within the horizontal cylinder section 24 and extends out from the head section 14 and the retaining section 114 is located within the vertical cylinder section 40. Thus, the extension 110 passes through the side opening of the head section 14 of the adapter 10 and the interior vertical wall 26 is against the retaining section 114 of the extension 110. Then, the operator can depress the trigger mechanism 6 of the hand drill 2 and, in this manner, rotation of the shaft section 12 of the adapter 10 causes the head section 14 to correspondingly rotate. This, in turn, causes one of the side edges 34 (depending upon the direction of rotation of the shaft section and the head section) to contact one of the sides of the retaining section 114 of the extension 110 and, in this manner, the power or torque transmitted by the hand drill 2 is transferred through the head section 14 which in turn is transferred to the extension and this causes the extension 110 to rotate about its rotation axis. This in turn, causes the engagement portion 109 of the insert fitting 103 or 104 to be threaded into the flexible hose 4. While section 112 has been described as hexagonal, it will be appreciated that it can be configured to be any non-round shape.

The extension 110 can be manufactured with or without the retaining section 114 and it can be used with or without the adapter 10. The present invention conforms to conventional forms of manufacture or any other conventional way known to one skilled in the art, and is of simple construction and is easy to use.

Defined in detail, the present invention is an adapter used in conjunction with a hand drill for facilitating the installation of a right-angle elbow insert fitting into a flexible hose of a sprinkler or irrigation system, the elbow insert fitting having an engagement portion and a connection portion perpendicular to the engagement portion, the adapter comprising: (a) a generally cylindrical body having a hexagonal shaped shaft section and a retaining head section, the shaft section for removably connecting the cylindrical body to the hand drill and transmitting the torque power of the hand drill to the retaining head section, the retaining head section integrally connected to the shaft section and adapted to rotate the elbow insert fitting when the shaft section is rotated by the hand drill; and (b) the head section having a center cavity with a front opening and a laterally extending opening, the front and laterally extending openings form a horizontal channel and a vertical channel which intersects with the horizontal channel, the horizontal and vertical channels respectively shaped and adapted for receiving the engagement portion and the connection portion of the elbow insert fitting; (c) whereby the cylindrical body of the adapter drives the engagement portion of the elbow insert fitting into the flexible hose to facilitate and speed up the installation of the elbow insert fitting to the flexible hose of the sprinkler or irrigation system.

Defined broadly, the present invention is an adapter used in conjunction with a hand drill for facilitating the installation of an elbow insert fitting into a flexible hose of a sprinkler or irrigation system, the elbow insert fitting having an engagement portion and a connection portion perpendicular to the engagement portion, the adapter comprising: (a) a cylindrical body having a shaft section and a head section, the shaft section for removably connecting the cylindrical body to the hand drill and transmitting the torque power of the hand drill to the head section, the head section connected to the shaft section and adapted to rotate the elbow insert fitting when the shaft section is rotated by the hand drill; and (b) the head section having a horizontal channel with a front opening and a vertical channel with a laterally extending opening, such that the vertical channel intersects with the horizontal channel, the horizontal and vertical channels respectively shaped and adapted for receiving the engagement portion and the connection portion of the elbow insert fitting; (c) whereby the cylindrical body of the adapter drives the engagement portion of the elbow insert fitting into the flexible hose to facilitate and speed up the installation of the elbow insert fitting to the flexible hose of the sprinkler or irrigation system.

Defined more broadly, the present invention is an adapter used in conjunction with a driving means for facilitating the installation of an elbow insert fitting into a hose of a sprinkler or irrigation system, the elbow insert fitting having an engagement portion and a connection portion, the adapter comprising: (a) driving connection means for removably connecting the adapter to the driving means and transmitting the torque power of the driving means to the adapter; (b) a head connected to the driving connection means adapted to receive and rotate the elbow insert fitting when the driving connection means is rotated by the driving means; and (c) the head having a first channel with an opening and a second channel with a laterally extending opening, such that the second channel intersects with the first channel, the first and second channels respectively shaped and adapted for receiving the engagement portion and the connection portion of the elbow insert fitting; (d) whereby the adapter drives the engagement portion of the elbow insert fitting into the hose to facilitate and speed up the installation of the elbow insert fitting to the hose of the sprinkler or irrigation system.

Further defined in detail, the present invention is an apparatus used in conjunction with a hand drill for facilitating the installation of an insert fitting into a flexible hose of a sprinkler or irrigation system, the insert fitting having an engagement portion and a connection portion perpendicular to the engagement portion, the apparatus comprising: (a) an extension having a retaining section and a hexagonal shaped driven insert section sized to press-fit into the connection portion of the insert fitting; (b) an adapter having a generally cylindrical body, the cylindrical body having a hexagonal shaped shaft section and a retaining head section, the shaft section for removably connecting the cylindrical body to the hand drill and transmitting the torque power of the hand drill to the retaining head section which in turn is transmitted to the extension, the retaining head section integrally connected to the shaft section and adapted to rotate the extension when the shaft section is rotated by the hand drill; and (c) the head section having a center cavity with a front opening and a laterally extending opening, the front and laterally extending openings form a horizontal channel and a vertical channel which intersects with the horizontal channel, the horizontal and vertical channels respectively shaped and adapted for receiving the hexagonal shaped driven insert section and the retaining section of the extension; (d) whereby the cylindrical body of the adapter drives the extension which in turn drives the insert fitting into the flexible hose to facilitate and speed up the installation of the insert fitting to the flexible hose of the sprinkler or irrigation system.

Further defined broadly, the present invention is an apparatus used in conjunction with a hand drill for facilitating the installation of an insert fitting into a flexible hose of a sprinkler or irrigation system, the insert fitting having an engagement portion and a connection portion perpendicular to the engagement portion, the apparatus comprising: (a) an extension having a retaining section and a driven insert section, the driven insert section having at least one flat side segment sized to press-fit into the connection portion of the insert fitting; (b) a cylindrical body having a shaft section and a head section, the shaft section for removably connecting the cylindrical body to the hand drill and transmitting the torque power of the hand drill to the head section which in turn is transmitted to the extension, the head section connected to the shaft section and adapted to rotate the extension when the shaft section is rotated by the hand drill; and (c) the head section having a horizontal channel with a front opening and a vertical channel with a laterally extending opening, such that the vertical channel intersects with the horizontal channel, the horizontal and vertical channels respectively shaped and adapted for receiving the driven insert section and the retaining section of the extension; (d) whereby the cylindrical body of the adapter drives the extension which in turn drives the insert fitting into the flexible hose to facilitate and speed up the installation of the insert fitting to the flexible hose of the sprinkler or irrigation system.

Further defined more broadly, the present invention is an apparatus used in conjunction with a driving means for facilitating the installation of an insert fitting into a hose of a sprinkler or irrigation system, the insert fitting having an engagement portion and a connection portion, the apparatus comprising: (a) an extension having a retaining section and a driven section, the driven section having at least one flat side segment sized to press-fit into the connection portion of the insert fitting; (b) an adapter having a driving connection means and a head, the driving connection means for removably connecting the adapter to the driving means and transmitting the torque power of the driving means to the adapter which in turn is transmitted to the extension, the head connected to the driving connection means and adapted to receive and rotate the retaining section of the extension when the driving connection means is rotated by the driving means; and (c) the head having a first channel with an opening and a second channel with a laterally extending opening, such that the second channel intersects with the first channel, the first and second channels respectively shaped and adapted for receiving the driven section and the retaining section of the extension; (d) whereby the adapter drives the extension which in turn drives the insert fitting into the hose to facilitate and speed up the installation of the insert fitting to the hose of the sprinkler or irrigation system.

Of course the present invention is not intended to be restricted to any particular form or arrangement, or any specific embodiment, or any specific use, disclosed herein, since the same may be modified in various particulars or relations without departing from the spirit or scope of the claimed invention hereinabove shown and described of which the apparatus or method shown is intended only for illustration and disclosure of an operative embodiment and not to show all of the various forms or modifications in which this invention might be embodied or operated.

The present invention has been described in considerable detail in order to comply with the patent laws by providing full public disclosure of at least one of its forms. However, such detailed description is not intended in any way to limit the broad features or principles of the present invention, or the scope of the patent to be granted. Therefore, the invention is to be limited only by the scope of the appended claims.

What is claimed is:

1. An adapter used in conjunction with a hand drill for facilitating the installation of a right-angle elbow insert fitting into a flexible hose of a sprinkler or irrigation system, the elbow insert fitting having an engagement portion and a connection portion perpendicular to the engagement portion, the adapter comprising:
a. a generally cylindrical body having a hexagonal shaped shaft section and a retaining head section, the shaft section for removably connecting the cylindrical body to said hand drill and transmitting the torque power of said hand drill to the retaining head section, the retaining head section integrally connected to the shaft section and adapted to rotate said elbow insert fitting when the shaft section is rotated by said hand drill; and
b. said head section having a center cavity with a front opening and a laterally extending opening, the front and laterally extending openings form a horizontal channel and a vertical channel which intersects with the horizontal channel, the horizontal and vertical channels respectively shaped and adapted for receiving said engagement portion and said connection portion of said elbow insert fitting;
c. whereby said cylindrical body of said adapter drives said engagement portion of said elbow insert fitting into said flexible hose to facilitate and speed up the installation of said elbow insert fitting to said flexible hose of said sprinkler or irrigation system.

2. The adapter in accordance with claim 1, wherein said cylindrical body is made out of hard plastic material.

3. An adapter used in conjunction with a hand drill for facilitating the installation of an elbow insert fitting into a flexible hose of a sprinkler or irrigation system, the elbow insert fitting having an engagement portion and a connection portion perpendicular to the engagement portion, the adapter comprising:
a. a cylindrical body having a shaft section and a head section, the shaft section for removably connecting the cylindrical body to said hand drill and transmitting the torque power of said hand drill to the head section, the head section connected to the shaft section and adapted to rotate said elbow insert fitting when the shaft section is rotated by said hand drill; and
b. said head section having a horizontal channel with a front opening and a vertical channel with a laterally extending opening, such that the vertical channel intersects with the horizontal channel, the horizontal and vertical channels respectively shaped and adapted for receiving said engagement portion and said connection portion of said elbow insert fitting;
c. whereby said cylindrical body of said adapter drives said engagement portion of said elbow insert fitting into said flexible hose to facilitate and speed up the installation of said elbow insert fitting to said flexible hose of said sprinkler or irrigation system.

4. The adapter in accordance with claim 3, wherein said cylindrical body is made out of plastic material.

5. The adapter in accordance with claim 3, wherein said shaft section is generally a hexagonal shape.

6. An adapter used in conjunction with a driving means for facilitating the installation of an elbow insert fitting into a hose of a sprinkler or irrigation system, the elbow insert fitting having an engagement portion and a connection portion, the adapter comprising:
a. driving connection means for removably connecting said adapter to said driving means and transmitting the torque power of said driving means to said adapter;
b. a head connected to said driving connection means adapted to receive and rotate said elbow insert fitting when said driving connection means is rotated by said driving means; and
c. said head having a first channel with an opening and a second channel with a laterally extending opening, such that the second channel intersects with the first channel, the first and second channels respectively shaped and adapted for receiving said engagement portion and said connection portion of said elbow insert fitting;
d. whereby said adapter drives said engagement portion of said elbow insert fitting into said hose to facilitate and speed up the installation of said elbow insert fitting to said hose of said sprinkler or irrigation system.

7. The adapter in accordance with claim 6, wherein said adapter is made out of plastic material.

8. The adapter in accordance with claim 6, wherein said driving connection means is generally a hexagonal shaped shaft.

9. The adapter in accordance with claim 6, wherein said first channel is a horizontal channel and said second channel is a vertical channel which intersects with the horizontal channel to form a right-angle cavity for receiving said engagement portion and said connection portion of said elbow insert fitting.

10. An apparatus used in conjunction with a hand drill for facilitating the installation of an insert fitting into a flexible hose of a sprinkler or irrigation system, the insert fitting having an engagement portion and a connection portion perpendicular to the engagement portion, the apparatus comprising:
a. an extension having a retaining section and a hexagonal shaped driven insert section sized to press-fit into said connection portion of said insert fitting;
b. an adapter having a generally cylindrical body, the cylindrical body having a hexagonal shaped shaft section and a retaining head section, the shaft section for removably connecting the cylindrical body to said hand drill and transmitting the torque power of said hand drill to the retaining head section which in turn is transmitted to said extension, the retaining head section integrally connected to the shaft section and adapted to rotate said extension when the shaft section is rotated by said hand drill; and
c. said head section having a center cavity with a front opening and a laterally extending opening, the front and laterally extending openings form a horizontal channel and a vertical channel which intersects with the horizontal channel, the horizontal and vertical channels respectively shaped and adapted for receiving said hexagonal shaped driven insert section and said retaining section of said extension;
d. whereby said cylindrical body of said adapter drives said extension which in turn drives said insert fitting into said flexible hose to facilitate and speed up the installation of said insert fitting to said flexible hose of said sprinkler or irrigation system.

11. The apparatus in accordance with claim 10, wherein said cylindrical body is made out of hard plastic material.

12. The apparatus in accordance with claim 10, wherein said extension is made out of hard plastic material.

13. The apparatus in accordance with claim 10, wherein said insert fitting is generally a T-shape.

14. The apparatus in accordance with claim 10, wherein said insert fitting is generally a straight shape.

15. An apparatus used in conjunction with a hand drill for facilitating the installation of an insert fitting into a flexible hose of a sprinkler or irrigation system, the insert fitting having an engagement portion and a connection portion perpendicular to the engagement portion, the apparatus comprising:
a. an extension having a retaining section and a driven insert section, the driven insert section having at least one flat side segment sized to press-fit into said connection portion of said insert fitting;
b. a cylindrical body having a shaft section and a head section, the shaft section for removably connecting the cylindrical body to said hand drill and transmitting the torque power of said hand drill to the head section which in turn is transmitted to said extension, the head section connected to the shaft section and adapted to rotate said extension when the shaft section is rotated by said hand drill; and
c. said head section having a horizontal channel with a front opening and a vertical channel with a laterally extending opening, such that the vertical channel intersects with the horizontal channel, the horizontal and vertical channels respectively shaped and adapted for receiving said driven insert section and said retaining section of said extension;
d. whereby said cylindrical body of said adapter drives said extension which in turn drives said insert fitting into said flexible hose to facilitate and speed up the installation of said insert fitting to said flexible hose of said sprinkler or irrigation system.

16. The apparatus in accordance with claim 15, wherein said cylindrical body is made out of plastic material.

17. The apparatus in accordance with claim 15, wherein said extension is made out of plastic material.

18. The apparatus in accordance with claim 15, wherein said insert fitting is generally a T-shape.

19. The apparatus in accordance with claim 15, wherein said insert fitting is generally a straight shape.

20. The apparatus in accordance with claim 15, wherein said shaft section of said adapter is generally a hexagonal shape.

21. An apparatus used in conjunction with a driving means for facilitating the installation of an insert fitting into a hose of a sprinkler or irrigation system, the insert fitting having an engagement portion and a connection portion, the apparatus comprising:
a. an extension having a retaining section and a driven section, the driven section having at least one flat side segment sized to press-fit into said connection portion of said insert fitting;
b. an adapter having a driving connection means and a head, the driving connection means for removably connecting the adapter to said driving means and transmitting the torque power of said driving means to the adapter which in turn is transmitted to said extension, the head connected to the driving connection means and adapted to receive and rotate said retaining section of said extension when said driving connection means is rotated by said driving means; and
c. said head having a first channel with an opening and a second channel with a laterally extending opening, such that the second channel intersects with the first channel, the first and second channels respectively shaped and adapted for receiving said driven section and said retaining section of said extension;
d. whereby said adapter drives said extension which in turn drives said insert fitting into said hose to facilitate and speed up the installation of said insert fitting to said hose of said sprinkler or irrigation system.

22. The apparatus in accordance with claim 21, wherein said adapter is made out of plastic material.

23. The apparatus in accordance with claim 21, wherein said extension is made out of plastic material.

24. The apparatus in accordance with claim 21, wherein said insert fitting is generally a T-shape.

25. The apparatus in accordance with claim 21, wherein said insert fitting is generally a straight shape.

26. The apparatus in accordance with claim 21, wherein said driving connection means of said adapter is generally a hexagonal shape.

27. The apparatus in accordance with claim 21, wherein said first channel is a horizontal channel and said second channel is a vertical channel which intersects with the horizontal channel to form a right-angle cavity for receiving said driven section and said retaining section of said extension.
